(19) United States
(12) Patent Application Publication
(10) Pub. No.: US 2004/0028964 A1
(43) Pub. Date: Feb. 12, 2004

(54) Apparatus and method for controlling the oxygen-to-carbon ratio of a fuel reformer

(76) Inventor: Rudolf M. Smaling, Bedford, MA (US)

Correspondence Address: BARNES & THORNBURG, 11 SOUTH MERIDIAN, INDIANAPOLIS, IN, 46204

(21) Appl. No.: 10/634,056

(22) Filed: Aug. 4, 2003

Related U.S. Application Data
(60) Provisional application No. 60/402,679, filed on Aug. 12, 2002.

(51) Int. Cl. H01M 8/04

(52) U.S. Cl. 429/19; 429/20; 429/24

(57) ABSTRACT

A fuel reforming assembly has a control unit electrically coupled to both a fuel reformer and a temperature sensor. The control unit is configured to communicate with the temperature sensor to determine the temperature of the reformate gas being produced by the fuel reformer and then adjust the air-to-fuel ratio of the air/fuel mixture being processed by the fuel reformer based thereon. A method of operating a fuel reformer is also disclosed

This application claims priority to U.S. Provisional Patent Application Serial No. 60/402,679 which was filed on Aug. 12, 2002, the disclosure of which is hereby incorporated by reference.

### FIELD OF THE DISCLOSURE

The present disclosure relates generally to a control system for a fuel reformer, and more particularly to a control system for controlling the oxygen-to-carbon ratio of a fuel reformer.

### BACKGROUND OF THE DISCLOSURE

Fuel reformers reform hydrocarbon fuel into a reformate gas such as hydrogen-rich gas. In the case of an onboard fuel reformer or a fuel reformer associated with a stationary power generator, the reformate gas produced by the fuel reformer may be utilized as fuel or fuel additive in the operation of an internal combustion engine. The reformate gas may also be utilized to regenerate or otherwise condition an emission abatement device associated with an internal combustion engine or as a fuel for a fuel cell.

### SUMMARY OF THE DISCLOSURE

According to one aspect of the present disclosure, there is provided a method of operating a fuel reformer that includes determining the temperature of the reformate gas being produced by the fuel reformer and adjusting the air-to-fuel ratio of the air/fuel mixture being processed by the fuel reformer based thereon.

In one specific implementation of this method, the temperature of the reformate gas is sensed with a temperature sensor. Moreover, the air-to-fuel ratio of the air/fuel mixture is adjusted by adjusting position of an air inlet valve associated with the fuel reformer. Specifically, to increase the air-to-fuel ratio of the air/fuel mixture, the air inlet valve is positioned so as to increase the flow of air advancing therethrough. Conversely, to decrease the air-to-fuel ratio of the air/fuel mixture, the air inlet valve is positioned so as to decrease the flow of air advancing therethrough.

In accordance with another aspect of the present disclosure, there is provided a fuel reforming assembly having a control unit electrically coupled to both a fuel reformer and a temperature sensor. The control unit is configured to communicate with the temperature sensor to determine the temperature of the reformate gas being produced by the fuel reformer and then adjust the air-to-fuel ratio of the air/fuel mixture being processed by the fuel reformer based thereon.

In one specific implementation, the control unit is also electrically coupled to an air inlet valve associated with the fuel reformer such that the air-to-fuel ratio of the air/fuel mixture may be adjusted by adjusting position of an air inlet valve. Specifically, to increase the air-to-fuel ratio of the air/fuel mixture, the control unit generates a control signal which causes the air inlet valve to increase the flow of air advancing therethrough. Conversely, to decrease the air-to-fuel ratio of the air/fuel mixture, the control unit generates a control signal which causes the air inlet valve to decrease the flow of air advancing therethrough.

### BRIEF DESCRIPTION OF THE DRAWINGS

FIG. 1 is a simplified block diagram of a fuel reforming assembly having a fuel reformer under the control of an electronic control unit;

FIG. 2 is a diagrammatic cross sectional view of a plasma fuel reformer which may be used in the construction of the fuel reforming assembly of FIG. 1; and

FIG. 3 is a flowchart of a control procedure executed by the control unit during operation of the fuel reforming assembly of FIG. 1.

### DETAILED DESCRIPTION OF ILLUSTRATIVE EMBODIMENTS

While the concepts of the present disclosure are susceptible to various modifications and alternative forms, specific exemplary embodiments thereof have been shown by way of example in the drawings and will herein be described in detail. It should be understood, however, that there is no intent to limit the disclosure to the particular forms disclosed, but on the contrary, the intention is to cover all modifications, equivalents, and alternatives following within the spirit and scope of the invention as defined by the appended claims.

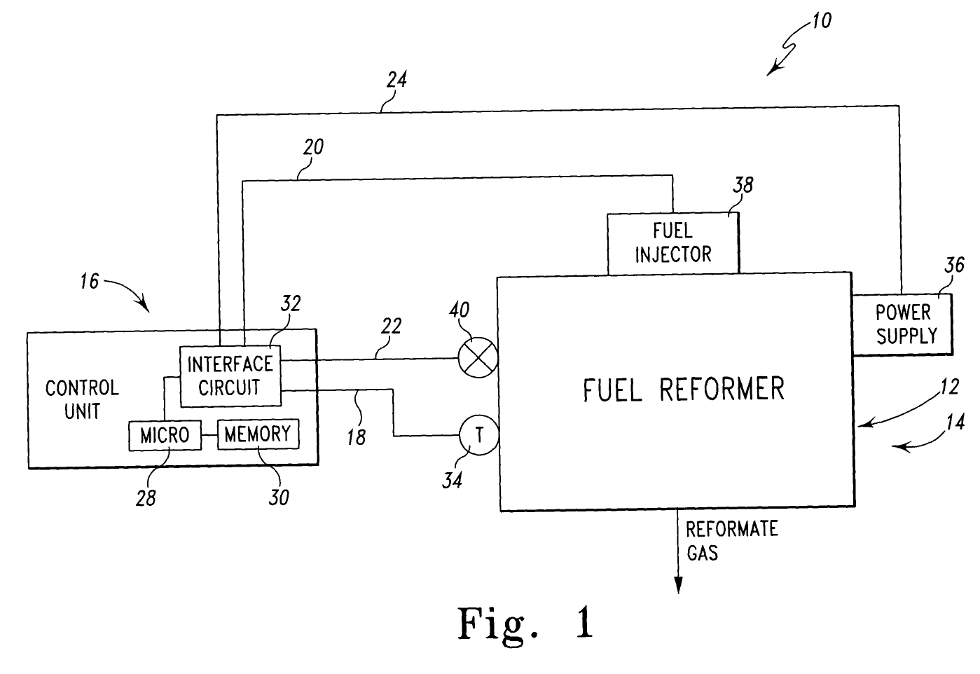

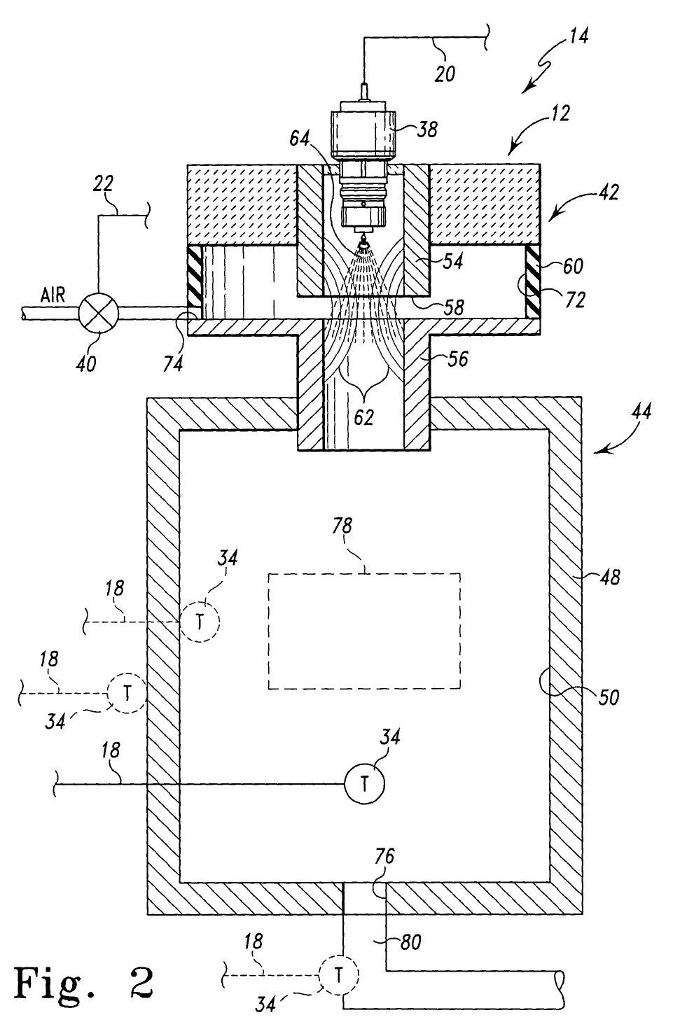

Referring now to FIGS. 1 and 2, there is shown a fuel reforming assembly 10 having a fuel reformer 14 and a control unit 16. The fuel reformer 14 reforms (i.e., converts) hydrocarbon fuels into a reformate gas that includes, amongst other things, hydrogen gas. As such, the fuel reformer 14, amongst other uses, may be used in the construction of an onboard fuel reforming system for a vehicle or as a component of a stationary power generator. In such a way, the reformate gas produced by the fuel reformer 14 may be utilized as fuel or fuel additive in the operation of an internal combustion engine thereby increasing the efficiency of the engine while also reducing emissions produced by the engine. The reformate gas from the fuel reformer 14 may also be utilized to regenerate or otherwise condition an emission abatement device associated with the internal combustion engine. In addition, if the vehicle or the stationary power generator is equipped with a fuel cell such as, for example, an auxiliary power unit (APU), the reformate gas from the fuel reformer 14 may also be used as a fuel for the fuel cell.

The fuel reformer 14 may be embodied as any type of fuel reformer such as, for example, a catalytic fuel reformer, a thermal fuel reformer, a steam fuel reformer, or any other type of partial oxidation fuel reformer. The fuel reformer 14 may also be embodied as a plasma fuel reformer 12. A plasma fuel reformer uses plasma to convert a mixture of air and hydrocarbon fuel into a reformate gas which is rich in, amongst other things, hydrogen gas and carbon monoxide. Systems including plasma fuel reformers are disclosed in U.S. Pat. No. 5,425,332 issued to Rabinovich et al.; U.S. Pat. No. 5,437,250 issued to Rabinovich et al.; U.S. Pat. No. 5,409,784 issued to Bromberg et al.; and U.S. Pat. No. 5,887,554 issued to Cohn, et al., the disclosures of each of which is hereby incorporated by reference. Additional examples of systems including plasma fuel reformers are disclosed in copending U.S. patent application Ser. No. 10/158,615 entitled “Low Current Plasmatron Fuel Converter Having Enlarged Volume Discharges” which was filed on May 30, 2002 by A. Rabinovich, N. Alexeev, L. Bromberg, D. Cohn, and A. Samokhin, along with copending U.S. patent application Ser. No. 10/411,917 entitled “Plasmatron Fuel Converter Having Decoupled Air Flow Control” which was filed on Apr. 11, 2003 by A. Rabinovich, N. Alexeev, L. Bromberg, D. Cohn, and A. Samokhin, the disclosures of both of which are hereby incorporated by reference.

For purposes of the following description, the concepts of the present disclosure will herein be described in regard to a plasma fuel reformer. However, as described above, the fuel reformer of the present disclosure may be embodied as any type of fuel reformer, and the claims attached hereto should not be interpreted to be limited to any particular type of fuel reformer unless expressly defined therein.

As shown in FIG. 2, the plasma fuel reformer 12 includes a plasma-generating assembly 42 and a reactor 44. The reactor 44 includes a reactor housing 48 having a reaction chamber 50 defined therein. The plasma-generating assembly 42 is secured to an upper portion of the reactor housing 48. The plasma-generating assembly 42 includes an upper electrode 54 and a lower electrode 56. The electrodes 54, 56 are spaced apart from one another so as to define an electrode gap 58 therebetween. An insulator 60 electrically insulates the electrodes from one another.

The electrodes 54, 56 are electrically coupled to an electrical power supply 36 (see FIG. 1) such that, when energized, a plasma arc 62 is created across the electrode gap 58 (i.e., between the electrodes 54, 56). A fuel input mechanism such as a fuel injector 38 injects a hydrocarbon fuel 64 into the plasma arc 62. The fuel injector 38 may be any type of fuel injection mechanism which injects a desired amount of fuel into plasma-generating assembly 42. In certain configurations, it may be desirable to atomize the fuel prior to, or during, injection of the fuel into the plasma-generating assembly 42. Such fuel injector assemblies (i.e., injectors which atomize the fuel) are commercially available.

The lower electrode 56 extends downwardly into the reactor housing 48. As such, gas (either reformed or partially reformed) exiting the plasma arc 62 is advanced into the reaction chamber 50. One or more catalysts 78 are positioned in reaction chamber 50. The catalysts 78 complete the fuel reforming process, or otherwise treat the gas, prior to exit of the reformate gas through a gas outlet 76.

As shown in FIG. 2, the plasma fuel reformer 12 has a temperature sensor 34 associated therewith. The temperature sensor 34 is used to determine the temperature of the reformate gas produced by the plasma fuel reformer 12. The temperature sensor 34 may be located in any number of locations. In particular, as shown in solid lines, the temperature sensor 34 may be positioned within the reaction chamber 50 to sense the temperature of the reformate gas therein. Alternatively, as shown in phantom, the temperature sensor 34 may be positioned so as to sense the temperature of the reformate gas advancing through a gas conduit 80 subsequent to being exhausted through the outlet 76.

It should also be appreciated that the temperature of the reformate gas may be determined indirectly. In particular, as shown in phantom, the temperature of either the inner surface or the outer surface of the reactor housing 48 may be sensed. Moreover, the temperature of other structures such as, for example, the substrate associated with the catalyst 78 may similarly be sensed. In any such a case, the indirect temperature sensed by the temperature sensor 34 is indicative of, or otherwise may be correlated to, the temperature of the reformate gas produced by the plasma fuel reformer 12. As such, the calculations performed by the herein described methods and systems may be adjusted to account for the use of such an indirect temperature measurements. Alternatively, the output from such an indirect gas temperature measurement may be extrapolated to a corresponding direct gas temperature or otherwise adjusted prior to input into the calculations performed by the herein described methods and systems.

Hence, it should be appreciated that the herein described concepts are not intended to be limited to any particular method or device for determining the temperature of the reformate gas produced by the plasma fuel reformer 12. In particular, the reformats gas temperature may be determined by use any type of temperature sensor, located in any sensor location, and utilizing any methodology (e.g., either direct or indirect) for obtaining temperature values associated with the reformate gas.

As shown in FIG. 2, the plasma-generating assembly 42 has an annular air chamber 72. Pressurized air is advanced into the air chamber 72 through an air inlet 74 and is thereafter directed radially inwardly through the electrode gap 58 so as to “bend” the plasma arc 62 inwardly. Such bending of the plasma arc 62 ensures that the injected fuel 64 is directed through the plasma arc 62. Such bending of the plasma arc 62 also reduces erosion of the electrodes 56, 58.

Moreover, advancement of air into the electrode gap 58 also produces a desired mixture of air and fuel (“air/fuel mixture”). In particular, the plasma reformer 12 reforms or otherwise processes the fuel in the form of a mixture of air and fuel. The oxygen-to-carbon ratio of the mixture being reformed by the fuel reformer is controlled via control of the air-to-fuel ratio of the air/fuel mixture being processed by the reformer. As such, the plasma fuel reformer 12 has an air inlet valve 40 associated therewith. The air inlet valve 40 may be embodied as any type of electronically controlled air valve. The air inlet valve 40 may be embodied as a discrete device, as shown in FIG. 2, or may be integrated into the design of the plasma fuel reformer 12. In either case, the air inlet valve 40 controls the amount of air that is introduced into the plasma-generating assembly 42.

In such a way, operation of the air inlet valve 40 may be used to control the air-to-fuel ratio of the air/fuel mixture being processed by the plasma fuel reformer 12. In particular, by positioning the air inlet valve 40 so as to increase the flow of air therethrough, the air-to-fuel ratio of the air/fuel mixture being processed by the fuel reformer 12 may be increased. Conversely, by positioning the air inlet valve 40 so as to decrease the flow of air therethrough, the air-to-fuel ratio of the air/fuel mixture may be decreased.

As shown in FIG. 1, the plasma fuel reformer 12 and its associated components are under the control of the control unit 16. In particular, the temperature sensor 34 is electrically coupled to the electronic control unit 16 via a signal line 18, the fuel injector 38 is electrically coupled to the electronic control unit 16 via a signal line 20, the air inlet valve 40 is electrically coupled to the electronic control unit 16 via a signal line 22, and the power supply 36 is electrically coupled to the electronic control unit 16 via a signal line 24. Although the signal lines 18, 20, 22, 24 are shown schematically as a single line, it should be appreciated that the signal lines may be configured as any type of signal carrying assembly which allows for the transmission of electrical signals in either one or both directions between the electronic control unit 16 and the corresponding component. For example, any one or more of the signal lines 18, 20, 22, 24 may be embodied as a wiring harness having a number of signal lines which transmit electrical signals between the electronic control unit 16 and the corresponding component. It should be appreciated that any number of other wiring configurations may also be used. For example, individual signal wires may be used, or a system utilizing a signal multiplexer may be used for the design of any one or more of the signal lines 18, 20, 22, 24. Moreover, the signal lines 18, 20, 22, 24 may be integrated such that a single harness or system is utilized to electrically couple some or all of the components associated with the plasma fuel reformer 12 to the electronic control unit 16.

The electronic control unit 16 is, in essence, the master computer responsible for interpreting electrical signals sent by sensors associated with the plasma fuel reformer 12 and for activating electronically-controlled components associated with the plasma fuel reformer 12 in order to control the plasma fuel reformer 12. For example, the electronic control unit 16 of the present disclosure is operable to, amongst many other things, determine the beginning and end of each injection cycle of fuel into the plasma-generating assembly 42, calculate and control the amount and ratio of air and fuel to be introduced into the plasma-generating assembly 42, determine the temperature of the reformate gas produced by the plasma fuel reformer 12, determine the power level to supply to the plasma fuel reformer 12.

To do so, the electronic control unit 16 includes a number of electronic components commonly associated with electronic units which are utilized in the control of electromechanical systems. For example, the electronic control unit 16 may include, amongst other components customarily included in such devices, a processor such as a microprocessor 28 and a memory device 30 such as a programmable read-only memory device (“PROM”) including erasable PROM's (EPROM's or EEPROM's). The memory device 30 is provided to store, amongst other things, instructions in the form of, for example, a software routine (or routines) which, when executed by the processing unit, allows the electronic control unit 16 to control operation of the plasma fuel reformer 12.

The electronic control unit 16 also includes an analog interface circuit 32. The analog interface circuit 32 converts the output signals from the various fuel reformer sensors (e.g., the temperature sensor 34) into a signal which is suitable for presentation to an input of the microprocessor 28. In particular, the analog interface circuit 32, by use of an analog-to-digital (A/D) converter (not shown) or the like, converts the analog signals generated by the sensors into a digital signal for use by the microprocessor 28. It should be appreciated that the A/D converter may be embodied as a discrete device or number of devices, or may be integrated into the microprocessor 28. It should also be appreciated that if any one or more of the sensors associated with the fuel reformer 14 generate a digital output signal, the analog interface circuit 32 may be bypassed.

Similarly, the analog interface circuit 32 converts signals from the microprocessor 28 into an output signal which is suitable for presentation to the electrically-controlled components associated with the plasma fuel reformer 12 (e.g., the fuel injector 38, the air inlet valve 40, or the power supply 36). In particular, the analog interface circuit 32, by use of a digital-to-analog (D/A) converter (not shown) or the like, converts the digital signals generated by the microprocessor 28 into analog signals for use by the electronically-controlled components associated with the fuel reformer 12 such as the fuel injector 38, the air inlet valve 40, or the power supply 36. It should be appreciated that, similar to the A/D converter described above, the D/A converter may be embodied as a discrete device or number of devices, or may be integrated into the microprocessor 28. It should also be appreciated that if any one or more of the electronically-controlled components associated with the plasma fuel reformer 12 operate on a digital input signal, the analog interface circuit 32 may be bypassed.

Hence, the electronic control unit 16 may be operated to control operation of the plasma fuel reformer 12. In particular, the electronic control unit 16 executes a routine including, amongst other things, a closed-loop control scheme in which the electronic control unit 16 monitors outputs of the sensors associated with the plasma fuel reformer 12 in order to control the inputs to the electronically-controlled components associated therewith. To do so, the electronic control unit 16 communicates with the sensors associated with the fuel reformer in order to determine, amongst numerous other things, the amount, temperature, and/or pressure of air and/or fuel being supplied to the plasma fuel reformer 12, the amount of oxygen in the reformate gas, the temperature of the fuel reformer or the reformate gas, and the composition of the reformate gas. Armed with this data, the electronic control unit 16 performs numerous calculations each second, including looking up values in preprogrammed tables, in order to execute algorithms to perform such functions as determining when or how long the fuel reformer's fuel injector or other fuel input device is opened, controlling the power level input to the fuel reformer, controlling the amount of air advanced through air inlet valve, etcetera.

In an exemplary embodiment, the aforedescribed control scheme includes a routine for controlling the oxygen-to-carbon ratio of the air/fuel mixture being processed by the fuel reformer 14. In particular, in certain fuel reformer embodiments, control of the air/fuel mixture within a relatively narrow range of oxygen-to-carbon ratio is desirable. For example, if the oxygen-to-carbon ratio is less than, for example, 1.00, carbon black (e.g., soot) may form in the fuel reformer's reactor thereby potentially reducing the efficiency of the plasma fuel reformer 12, or in some cases ceasing operation of the fuel reformer 12. On the other hand, if the oxygen-to-carbon ratio is greater than, for example, 1.05, gas temperatures within the plasma fuel reformer's reactor 44 may exceed 850° C. thereby potentially damaging or even destroying the catalyst 78 positioned in the reactor 44. As such, the control routine executed by the control unit 16 includes a scheme for controlling the oxygen-to-carbon ratio of the air/fuel mixture processed by the fuel reformer 14 within a predetermined range. In an exemplary embodiment, the control unit 16 controls the oxygen-to-carbon ratio within a range of 1.03+/−0.02.

One exemplary way to do so is by monitoring the temperature of the reformate gas being produced by the plasma fuel reformer 12. In particular, from chemical reaction equations it can be derived that the theoretical maximum reformate gas temperature, i.e., the adiabatic temperature (T_{A}), is a direct function of the oxygen-to-carbon ratio of the air/fuel mixture processed by the fuel reformer:

$${T}_{A} = \frac{{\dot{Q}}_{PF} - {\dot{Q}}_{PG}}{{q}_{H2} {\dot{m}}_{H2} + {q}_{CO} {\dot{m}}_{CO} + {q}_{CO2} {\dot{m}}_{CO2} + {q}_{N2} {\dot{m}}_{N2}} + {T}_{0}$$

where \dot{Q}_{PF}=plasma fuel reformer input fuel energy (kW), \dot{Q}_{PG}=plasma fuel reformer output gas energy (kW), q_{H2}=specific heat of hydrogen (kJ/kg/K), \dot{m}_{H2}=plasma fuel reformer output hydrogen mass flow (gr/s), q_{CO}=specific heat of carbon monoxide (kJ/kg/K), \dot{m}_{CO}=plasma fuel reformer output carbon monoxide mass flow (gr/s), q_{CO2}=specific heat of carbon dioxide (kJ/kg/K), \dot{m}_{CO2}=plasma fuel reformer output carbon dioxide mass flow (gr/s), q_{N2}=specific heat of nitrogen (kJ/kg/K), \dot{m}_{N2}=plasma fuel reformer output carbon monoxide mass flow (gr/s), and T₀=inlet air temperature. Solving the equation and inserting the appropriate values for parameters arrives at the following equation:

$${T}_{A} = \frac{{\dot{Q}}_{PF} - {\dot{Q}}_{PG}}{{q}_{H2} {\dot{m}}_{H2} + {q}_{CO} {\dot{m}}_{CO} + {q}_{CO2} {\dot{m}}_{CO2} + {q}_{N2} {\dot{m}}_{N2}} + {T}_{0}$$

where (O/C)=plasma fuel reformer input oxygen-to-carbon ratio.

As such, for the exemplary control range of 1.03+/−0.02 (i.e., O/C=1.01 to 1.05), T_{A} ranges from 750° C. to 830° C. Thus, the temperature sensor 34 may be used as a closed-loop feedback mechanism to maintain the temperature of the reformate gas at a predetermined temperature value or “set point” of 790° C. (which corresponds with O/C=1.03 adjusted for any energy losses and/or mixture in-homogeneities). In other words, the temperature of the reformate gas produced by the plasma fuel reformer 12 may be used to maintain the oxygen-to-carbon ratio within a desired range. Specifically, if the temperature of the reformate gas produced by the plasma fuel reformer 12 drops below the set point (e.g., 790° C.), the oxygen-to-carbon ratio of the air/fuel mixture being processed by the fuel reformer 12 is increased by the control unit 16. Conversely, if the temperature of the reformats gas produced by the plasma fuel reformer 12 climbs above the set point (e.g., 790° C.), the oxygen-to-carbon ratio of the air/fuel mixture being processed by the fuel reformer 12 is decreased by the control unit 16.

As described above, the oxygen-to-carbon ratio of the mixture being reformed by the plasma fuel reformer 12 is controlled via control of the air-to-fuel ratio of the air/fuel mixture being processed by the reformer. To do so, either the fuel flow (as controlled by the fuel injector 38) or the air flow (as controlled by the air inlet valve 40), or both, may be adjusted to likewise adjust the air-to-fuel ratio of the air/fuel mixture.

In one exemplary implementation, the air flow is the parameter adjusted to maintain the desired oxygen-to-carbon range. In particular, given that mass flow rate of fuel is readily determined from fuel injector specifications, fuel pressure, and pulse width, the control scheme of the present disclosure controls air flow to correspond to fuel flow. Moreover, by varying the air flow, a desired minimum mass flow rate of fuel may be maintained. In particular, it may be desirable to maintain a certain minimum mass flow rate of reformate gas output during operation of the plasma fuel reformer 12 in order to satisfy the input requirements of the device to which the plasma fuel reformer is coupled (e.g., the intake manifold of an engine, an emission abatement device, a fuel cell, etcetera). As such, air flow may be varied in order to allow a desired minimum mass flow rate of fuel to be processed by the plasma fuel reformer 12 during operation of the plasma fuel reformer 12.

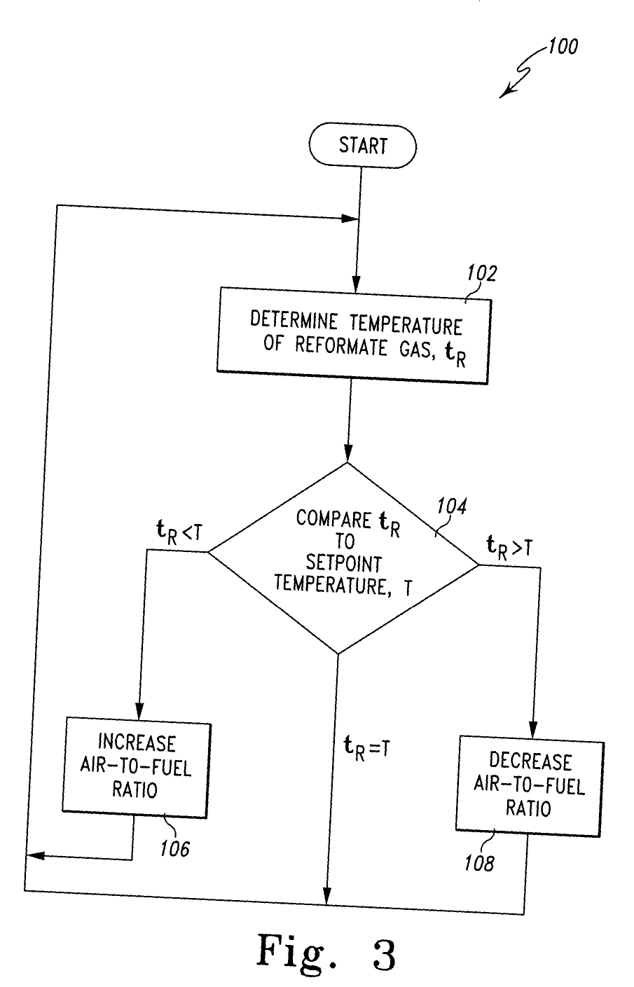

Referring now to FIG. 3, there is shown a control routine 100 for controlling the oxygen-to-carbon ratio of the air/fuel mixture processed by the plasma fuel reformer 12 during operation thereof. The control routine 100 begins with step 102 in which the control unit 16 determines the temperature of the reformats gas (t_{R}) being produced by the plasma fuel reformer. In particular, the control unit 16 scans or otherwise reads the signal line 18 in order to monitor output from the temperature sensor 34. As described above, the output signals produced by the temperature sensor 34 are indicative of the temperature of the reformate gas (t_{R}). Once the control unit 16 has determined the temperature of the reformate gas (t_{R}), the control routine 100 advances to step 104.

In step 104, the control unit 16 compares the sensed temperature of the reformate gas (t_{R}) to a set point temperature (T). In particular, as described herein, a predetermined temperature value or set point may be established which corresponds to a target oxygen-to-carbon ratio within a range. In the exemplary embodiment described herein, a set point temperature of 790° C. (which corresponds with O/C=1.03 adjusted for any energy losses and/or mixture in-homogeneities) is utilized. As such, in step 104, the control unit 16 compares the temperature of the reformate gas (t_{R}) to the set point temperature (T). If the temperature of the reformate gas equals the set point temperature (T), the control routine 100 loops back to step 102 to continue monitoring the output from the temperature sensor 34. However, if the temperature of the reformate gas (t_{R}) is less than the set point temperature (T), the control routine advances to step 106, whereas if the temperature of the reformate gas (t_{R}) is greater than the set point temperature (T), the control routine advances to step 108.

In step 106, the control unit 16 increases the oxygen-to-carbon ratio of the air/fuel mixture being processed by the plasma fuel reformer 12. In particular, the control unit 16 generates a control signal on the signal line 22 thereby adjusting position of the inlet air valve 40. More specifically, the control unit 16 adjusts the position of the air inlet valve 40 so as to increase the flow of air advancing therethrough by a calculated amount to correspond with a desired increase in air-to-fuel ratio of the air/fuel mixture. Thereafter, the control routine loops back to step 102 to continue monitoring the output from the temperature sensor 34.

Referring back to step 104, if the temperature of the reformate gas (t_{R}) is greater than the set point temperature (T), the control routine advances to step 108. In step 108, the control unit 16 decreases the oxygen-to-carbon ratio of the air/fuel mixture being processed by the plasma fuel reformer 12. In particular, the control unit 16 generates a control signal on the signal line 22 thereby adjusting position of the inlet air valve 40. More specifically, the control unit 16 adjusts the position of the air inlet valve 40 so as to decrease the flow of air advancing therethrough by a calculated amount to correspond with a desired decrease in air-to-fuel ratio of the air/fuel mixture. Thereafter, the control routine loops back to step 102 to continue monitoring the output from the temperature sensor 34.

While the concepts of the present disclosure have been illustrated and described in detail in the drawings and foregoing description, such an illustration and description is to be considered as exemplary and not restrictive in character, it being understood that only the illustrative embodiments have been shown and described and that all changes and modifications that come within the spirit of the disclosure are desired to be protected.

There are a plurality of advantages of the concepts of the present disclosure arising from the various features of the systems described herein. It will be noted that alternative embodiments of each of the systems of the present disclosure may not include all of the features described yet still benefit from at least some of the advantages of such features. Those of ordinary skill in the art may readily devise their own implementations of a system that incorporate one or more of the features of the present disclosure and fall within the spirit and scope of the invention as defined by the appended claims.

1. A method of operating a fuel reformer, comprising the steps of:
determining the temperature of a reformate gas produced by the fuel reformer, and
adjusting an air-to-fuel ratio of an air/fuel mixture processed by the fuel reformer based on the temperature of the reformate gas.

2. The method of claim 1, wherein:
the fuel reformer has an air inlet valve associated therewith, and
the adjusting step comprises adjusting position of the air inlet valve based on the temperature of the reformate gas.

3. The method of claim 1, wherein:
the determining step comprises comparing the temperature of the reformate gas to a predetermined temperature value, and
the adjusting step comprises reducing the air-to-fuel ratio of the air/fuel mixture if the temperature of the reformate gas is greater than the predetermined temperature value.

4. The method of claim 3, wherein:
the fuel reformer has an air inlet valve associated therewith, and
reducing the air-to-fuel ratio of the air/fuel mixture comprises adjusting position of the air inlet valve so as to reduce a flow of air advancing therethrough.

5. The method of claim 1, wherein:
the determining step comprises comparing the temperature of the reformate gas to a predetermined temperature value, and
the adjusting step comprises increasing the air-to-fuel ratio of the air/fuel mixture if the temperature of the reformate gas is less than the predetermined temperature value.

6. The method of claim 5, wherein:
the fuel reformer has an air inlet valve associated therewith, and
increasing the air-to-fuel ratio of the air/fuel mixture comprises adjusting position of the air inlet valve so as to increase a flow of air advancing therethrough.

7. The method of claim 1, wherein the determining step comprises sensing the temperature of the reformate gas with a temperature sensor.

8. A fuel reforming assembly, comprising:
a fuel reformer,
a temperature sensor, and
a controller electrically coupled to both the fuel reformer and the temperature sensor, wherein the controller comprises (i) a processor, and (ii) a memory device electrically coupled to the processor, the memory device having stored therein a plurality of instructions which, when executed by the processor, causes the processor to:
(a) monitor output from the temperature sensor so as to determine the temperature of a reformate gas produced by the fuel reformer, and
(b) adjust an air-to-fuel ratio of an air/fuel mixture processed by the fuel reformer based on the temperature of the reformate gas.

9. The fuel reforming assembly of claim 8, further comprising an electrically-controlled air inlet valve, wherein:
the air inlet valve is electrically coupled to the processor, and
the plurality of instructions, when executed by the processor, further cause the processor to adjust position of the air inlet valve based on the temperature of the reformate gas.

10. The fuel reforming assembly of claim 8, wherein the plurality of instructions, when executed by the processor, further cause the processor to:
(a) compare the temperature of the reformate gas to a predetermined temperature value, and
(b) reduce the air-to-fuel ratio of the air/fuel mixture if the temperature of the reformate gas is greater than the predetermined temperature value.

11. The fuel reforming assembly of claim 8, further comprising an electrically-controlled air inlet valve, wherein:
the air inlet valve is electrically coupled to the processor, and
the plurality of instructions, when executed by the processor, further cause the processor to:
(a) compare the temperature of the reformate gas to a predetermined temperature value, and
(b) adjust position of the air inlet valve so as to reduce a flow of air advancing therethrough if the temperature of the reformate gas is greater than the predetermined temperature value.

12. The fuel reforming assembly of claim 8, wherein the plurality of instructions, when executed by the processor, further cause the processor to:
(a) compare the temperature of the reformate gas to a predetermined temperature value, and
(b) increase the air-to-fuel ratio of the air/fuel mixture if the temperature of the reformate gas is less than the predetermined temperature value.

13. The fuel reforming assembly of claim 8, further comprising an electrically-controlled air inlet valve, wherein:
the air inlet valve is electrically coupled to the processor, and
the plurality of instructions, when executed by the processor, further cause the processor to:
(a) compare the temperature of the reformate gas to a predetermined temperature value, and
(b) adjust position of the air inlet valve so as to increase a flow of air advancing therethrough if the temperature of the reformate gas is less than the predetermined temperature value.

14. The fuel reforming assembly of claim 8, wherein:
the fuel reformer comprises a reactor housing, and
the temperature sensor is positioned in the reactor housing.

15. The fuel reforming assembly of claim 8, wherein:
the fuel reformer comprises a reactor housing, and
the temperature sensor is positioned outside the reactor housing.

16. A method of operating a fuel reformer, the method comprising the steps of:
operating the fuel reformer so as to process an air/fuel mixture having a first air-to-fuel ratio during a first period of time,
determining the temperature of a reformate gas produced by the fuel reformer during the first period of time, and
operating the fuel reformer so as to process an air/fuel mixture having a second air-to-fuel ratio during a second period of time based on the temperature of the reformate gas, the air/fuel mixture having the second air-to-fuel ratio being different than the air/fuel mixture having the first air-to-fuel ratio.

17. The method of claim 16, wherein:
the fuel reformer has an air inlet valve associated therewith,
the step of operating the fuel reformer so as to process the first air/fuel mixture having a first air-to-fuel ratio comprises positioning the air inlet valve at a first valve position, and
the step of operating the fuel reformer so as to process the second air/fuel mixture having the second air-to-fuel ratio comprises positioning the air inlet valve at a second valve position, the second valve position being different that the first valve position.

18. The method of claim 16, wherein the determining step comprises sensing the temperature of the reformate gas with a temperature sensor.
